(19) United States
(12) Patent Application Publication
(10) Pub. No.: US 2020/0051197 A1
(43) Pub. Date: Feb. 13, 2020

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Fumiki OHTANI, Toyota-shi (JP); Hirofumi KAMIMARU, Fukuoka-shi (JP); Riho MATSUO, Nagoya-shi (JP); Shodai KATO, Toyota-shi (JP); Atsushi YOSHIDA, Tokyo-to (JP); Shunsuke TANIMORI, Susono-shi (JP)

(73) Assignee: TOYOTA JIDOSHA KABUSHIKI KAISHA, Toyota-shi (JP)

(21) Appl. No.: 16/532,992

(22) Filed: Aug. 6, 2019

(30) Foreign Application Priority Data
Aug. 9, 2018 (JP) 2018-150496

(51) Int. Cl. G06Q 50/30; G06Q 30/02; G01C 21/34

(52) U.S. Cl. CPC G06Q 50/30; G01C 21/3438; G06Q 30/0284

(57) ABSTRACT

Carpooling in a vehicle traveling to a predetermined place is promoted. A number of carpool passenger users who are users scheduled to carpool in a vehicle that travels to a predetermined place is acquired; a cost needed for potential users who are users different from the carpool passenger users to ride the vehicle is set on the basis of the number of carpool passenger users; and information on the cost is provided to the potential users present within a predetermined range from a scheduled path of the vehicle traveling to the predetermined place.

### CROSS REFERENCE TO RELATED APPLICATION

This application claims the benefit of Japanese Patent Application No. 2018-150496, filed on Aug. 9, 2018, which is hereby incorporated by reference herein in its entirety.

### BACKGROUND

### Technical Field

The present disclosure relates to an information processing apparatus, an information processing method, and a non-transitory storage medium.

### Description of the Related Art

In the field of ride-sharing by carpooling in vehicles, giving a financial incentive to users who ride vehicles in order to lead the users is known (see Patent document 1, for example).

### CITATION LIST

### Patent Document

[Patent document 1] Japanese Patent Laid-Open No. 2017-142177

### SUMMARY

An object of the present disclosure is to promote carpooling in a vehicle traveling to a predetermined place.

One aspect of the present disclosure is an information processing apparatus including a controller. The controller acquires a number of carpool passenger users who are users scheduled to carpool in a vehicle that travels to a predetermined place. The controller sets a cost needed for potential users who are users different from the carpool passenger users to ride the vehicle, on the basis of the number of carpool passenger users. The controller provides information on the cost to the potential users present within a predetermined range from a scheduled path of the vehicle traveling to the predetermined place.

One aspect of the present disclosure is an information processing method in a computer, including: acquiring a number of carpool passenger users who are users scheduled to carpool in a vehicle that travels to a predetermined place; setting a cost needed for potential users who are users different from the carpool passenger users to ride the vehicle, on the basis of the number of carpool passenger users; and providing information on the cost to the potential users present within a predetermined range from a scheduled path of the vehicle traveling to the predetermined place.

One aspect of the present disclosure is a non-transitory storage medium stored with an information processing program, the information processing program for causing a computer to: acquire a number of carpool passenger users who are users scheduled to carpool in a vehicle that travels to a predetermined place; set a cost needed for potential users who are users different from the carpool passenger users to ride the vehicle, on the basis of the number of carpool passenger users; and provide information on the cost to the potential users present within a predetermined range from a scheduled path of the vehicle traveling to the predetermined place.

The present disclosure can promote carpooling in a vehicle traveling to a predetermined place.

### BRIEF DESCRIPTION OF THE DRAWINGS

FIG. 1 is a diagram illustrating a schematic configuration of a carpool support system according to an embodiment;

FIG. 2 is a block diagram schematically illustrating one example of the configurations of a user terminal and a server constituting a carpool support system according to a first embodiment;

FIG. 3 is a diagram illustrating an example of the functional configuration of the server;

FIG. 4 is a diagram illustrating an example of the table configuration of information stored in a carpool passenger user information DB;

FIG. 5 is a diagram illustrating an example of the table configuration of vehicle information stored in a vehicle information DB;

FIG. 6 is a diagram illustrating an example of the table configuration of positional information stored in a positional information DB;

FIG. 7 is a diagram illustrating a relationship between the number of carpool passenger users and fare;

FIG. 8 is a diagram illustrating an example of the functional configuration of a user terminal;

FIG. 9 is a diagram illustrating an example of a screen for selecting a vehicle, displayed on the output unit of a potential user terminal;

FIG. 10 is an example flow chart of fare information providing processing according to the first embodiment;

FIG. 11 is a diagram illustrating a sequence of processing in the carpool support system according to the first embodiment;

FIG. 12 is a diagram illustrating an example of the functional configuration of a server according to a second embodiment;

FIG. 13 is a diagram illustrating an example of the table configuration of history information stored in a history information DB according to the second embodiment;

FIG. 14 is a diagram illustrating an example of a screen displayed on the output unit of a potential user terminal that has received estimated fare information according to the second embodiment; and

FIG. 15 is an example flow chart of processing for providing estimated fare information to a potential user, according to the second embodiment.

### DESCRIPTION OF THE EMBODIMENTS

An information processing apparatus, which is one aspect of the present disclosure, acquires the number of users (carpool passenger users) scheduled to ride the same vehicle to travel to a predetermined place. The predetermined place is, for example, the destination of the vehicle or a stopover of the vehicle. A carpool passenger user is a user whose travel to this predetermined place is already confirmed. A controller acquires the number of carpool passenger users, for example, by receiving a signal indicating a demand of riding a vehicle, from terminals owned by users. Note that the number of carpool passenger users may be the number of users who are actually riding a vehicle, or the number of users who are confirmed to ride a vehicle. The controller sets the cost of riding a vehicle, according to the number of carpool passenger users. For example, it is set so that the larger the number of carpool passenger users, the lower the cost for the users who ride thereafter. An upper limit or lower limit can be set for this cost.

The controller provides information on the cost set in this manner to potential users. Potential users are users who are present within a predetermined range from a path along which a vehicle is scheduled to travel to a predetermined place and who are yet to be scheduled to travel to the predetermined place. This predetermined range is, for example, a range in which carpool passenger users can ride, or a range in which the load on the driver of the vehicle or the vehicle is in an allowable range even if the path of the travel of the vehicle is changed. Examples of the load on the driver or vehicle include time load and cost load. Once information on cost is provided, for example, the cost is displayed on terminals owned by potential users. Potential users demand to travel to a predetermined place in some cases depending on the information on the provided cost. This can promote carpooling in a vehicle traveling to a predetermined place. When a potential user demands to ride a vehicle, the number of carpool passenger users increases, which further lowers the cost. This makes it easier to lead potential users to the predetermined place. For example, in the case where a commercial facility exists at the predetermined place, increasing the number of carpool passenger users can increase the number of people who buy products, thereby increasing sales.

In addition, when the potential user demands to carpool in the vehicle, the controller may generate the path passing through the location of the potential user and provide the generated path to the driver of the vehicle or the vehicle.

When a potential user demands to carpool in a vehicle, the controller can also generate a travel path of the vehicle so that the potential user can carpool in the vehicle. If the vehicle travels along this travel path, the potential user can ride the vehicle. Note that the travel path may be provided to the vehicle or the driver of the vehicle. In the case where the travel path is provided to the vehicle, the vehicle may automatically travel to a destination, or the travel path may be displayed on the display or the like of the vehicle in such a manner that the vehicle indicates the travel path to the driver. In the case where the travel path is provided to the driver of the vehicle, for example, information indicating a travel path may be transmitted to a terminal owned by the driver of the vehicle. Meanwhile, the travel path of the vehicle can be fixed. In this case, a location to be picked up by the vehicle may be predetermined, and carpool passenger users may travel to that pickup location on foot or the like. In this case, users present within a predetermined range from the pickup location are potential users.

In addition, the controller may set the cost so that the larger the number of carpool passenger users, the lower the cost.

A decrease in the cost of travel increases the probability that potential users demand to travel to a destination, so that more users can be collected at the destination. Note that the cost may be decreased each time the number of carpool passenger users increases by one, or each time the number of carpool passenger users increases by two or three or more. The number of carpool passenger users at which the cost changes may be arbitrarily determined.

In addition, the controller may calculate an estimated cost, which is the cost needed for the potential users to ride the vehicle scheduled to travel to the predetermined place in the future, on the basis of the number of carpool passenger users acquired in the past, and may provide information on the calculated estimated cost to the potential users.

The number of future carpool passenger users can be estimated on the basis of the number of carpool passenger users in the past. For example, there is correlation between the date, day, time, weather, or the like and the number of carpool passenger users in some cases. The number of future carpool passenger users can be estimated on the basis of this correlation. Aside from that, for example, in the event of a sale, event, or the like at a commercial facility, an increase in the number of carpool passenger users is estimated. In this case, a decrease in the cost of ride in a vehicle is estimated on the basis of the number of carpool passenger users in the past, so that providing that information to potential users can increase the number of carpool passenger users. This can further promote carpooling in a vehicle traveling to a predetermined place.

An embodiment of the present disclosure will now be described with reference to the accompanying drawings. The configurations in the embodiments below are merely illustrative, and the present disclosure is not limited to the configurations in the embodiments. Further, the embodiments below can be used in any possible combination.

### First Embodiment

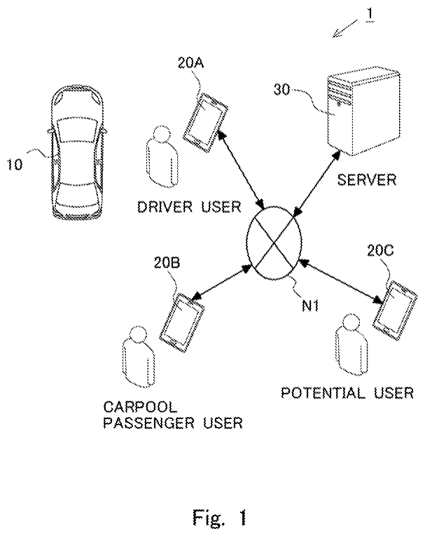

FIG. 1 is a diagram illustrating a schematic configuration of a carpool support system 1 according to an embodiment. In the example illustrated in FIG. 1, the carpool support system 1 includes a vehicle 10 driven by a driver user, a driver user terminal 20A used by the driver user, a carpool passenger user terminal 20B used by a carpool passenger user, a potential user terminal 20C used by a potential user, and a server 30. Note that the driver user is a user who carries the carpool passenger user to a predetermined place by driving the vehicle 10. Further, the carpool passenger user is a user scheduled to carpool in the vehicle 10 and confirmed to carpool in the vehicle 10. The potential user is a user who is not scheduled to carpool in the vehicle 10. There are multiple driver users, carpool passenger users, and potential users. In addition, the number of driver user terminals 20A and vehicles 10 is equal to the number of driver users using the carpool support system 1, the number of carpool passenger user terminals 20B is equal to the number of carpool passenger users using the carpool support system 1, and the number of potential user terminals 20C is equal to the number of potential users using the carpool support system 1. Note that vehicles 10 may be vehicles that perform automatic driving (hereinafter referred to as automatic driving vehicles). In this case, no driver users exist, driver user terminals 20A are terminals mounted in vehicles 10, and driver user terminals 20A move vehicles 10 along a travel path.

When not distinguished from each other, the driver user terminal 20A, the carpool passenger user terminal 20B, and the potential user terminal 20C are simply referred to as “user terminal 20” below. When not distinguished from each other, the driver user, carpool passenger user, and potential user are simply referred to as “user”. The user terminals 20 and the server 30 are connected to each other via a network N1. The network N1 is a worldwide public communication network, such as the Internet, and may be, for example, a wide area network (WAN) or other communication networks. In addition, the network N1 may include a telephone communication network such as that for cellular phones, or a wireless communication network such as Wi-Fi.

The carpool support system 1 provides potential users with information on the fare of the vehicle 10 heading to a predetermined place. Potential users demanding to ride the vehicle 10 change to carpool passenger users. The server 30 generates a travel path of the vehicle 10 so that all the carpool passenger users can be carried to the predetermined place. The generated travel path is transmitted to the driver user terminal 20A and the carpool passenger user terminals 20B. Note that the driver user terminal 20A may just display the received travel path on a map or guide to the travel direction of the vehicle 10 along the received travel path.

When any potential user terminal 20C exists within a predetermined range from a scheduled travel path of the vehicle 10, the server 30 transmits information on the fare of the vehicle 10 to this potential user terminal 20C. This fare is one example of the cost of riding the vehicle 10. The predetermined range is, for example, a range in which carpool passenger users can ride, or a range in which the load on the driver of the vehicle 10 or the vehicle 10 is in an allowable range even if the travel path is changed, for example, the area of the same city, town, or village. The scheduled travel path is a path along which the vehicle 10 is scheduled to travel and is generated so that the vehicle 10 can reach from the current location to the destination (the predetermined place). Note that when there is a carpool passenger user, the travel path of the vehicle 10 is changed so that the carpool passenger user can ride it. A location where the carpool passenger user gets in the vehicle is, for example, the current location of the carpool passenger user acquired from the carpool passenger user terminal 20B, or a location where the carpool passenger user demands to get in the vehicle. A location where the carpool passenger user demands to get in the vehicle may be a location pre-registered to the server 30. The fare of the vehicle 10 is set by the server 30, for example, so that it decreases with an increase in the number of carpool passenger users. Hence, when a potential user changes to a carpool passenger user by demanding to ride the vehicle 10, the fare of the vehicle 10 decreases according to the number of carpool passenger users.

Note that the fare that a carpool passenger user is supposed to pay is determined at the time when the carpool passenger user demands to ride the vehicle 10. Accordingly, after the fare for one carpool passenger user is confirmed, the fare for this carpool passenger user does not decrease even if the fare decreases upon addition of another carpool passenger user. Note that it is also possible to decrease the fare for that carpool passenger user like the fare for the other carpool passenger user. Each time the number of carpool passenger users increases, the server 30 generates a travel path so that the vehicle 10 goes through the location where the carpool passenger user gets in the vehicle, and transmits the travel path to the driver user terminal 20A. Note that the travel path of the vehicle 10 and the pickup location of the carpool passenger user may be fixed. In this case, the aforementioned predetermined range may be a range from which the carpool passenger user can move to the pickup location on foot.

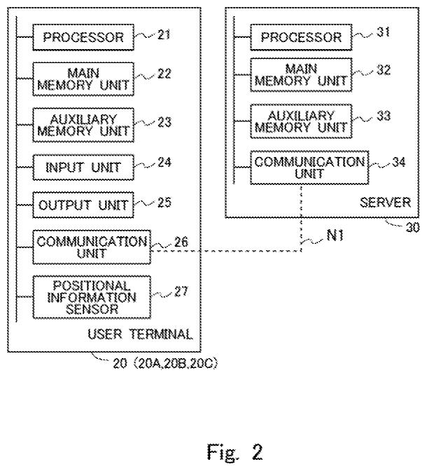

The hardware configurations of the user terminals 20 and the server 30 will now be described with reference to FIG. 2. FIG. 2 is a block diagram schematically illustrating one example of the configurations of the user terminals 20 and the server 30 constituting the carpool support system 1 according to this embodiment.

The server 30 has a typical computer configuration. The server 30 includes a processor 31, a main memory unit 32, an auxiliary memory unit 33, and a communication unit 34. They are connected to each other via a bus.

The processor 31 is a central processing unit (CPU), a digital signal processor (DSP), or the like. The processor 31 controls the server 30 and performs various logic operations for information processing. The processor 31 is one example of “controller”. The main memory unit 32 is a random access memory (RAM), a read only memory (ROM), or the like. The auxiliary memory unit 33 is an erasable programmable ROM (EPROM), a hard disk drive (HDD), a removal medium, or the like. The auxiliary memory unit 33 stores an operating system (OS), various programs, various tables, and the like. The processor 31 loads the programs stored in the auxiliary memory unit 33 into the work area of the main memory unit 32 and executes it, and the components are controlled through this execution of the programs. Thus, the server 30 implements a function meeting a predetermined objective. The main memory unit 32 and the auxiliary memory unit 33 are computer-readable recording media. Note that the server 30 may be a single computer or multiple computers in cooperation. Information stored in the auxiliary memory unit 33 may be stored in the main memory unit 32. Information stored in the main memory unit 32 may be stored in the auxiliary memory unit 33.

The communication unit 34 is a means for communication with the user terminals 20 via the network N1. The communication unit 34 is, for example, a wireless communication circuit for a local area network (LAN) interface board or wireless communication. The LAN interface board or the wireless communication circuit is connected to the network N1.

Note that a sequence of processing executed in the server 30 can be executed with a hardware or software. The hardware configuration of the server 30 is not limited to that illustrated in FIG. 2.

The user terminals 20 will now be explained. Each user terminal 20 is, for example, a smartphone, a cellular phone, a tablet terminal, a personal information terminal, a wearable computer (such as a smartwatch), a personal computer (PC), or other compact computers. Note that the driver user terminal 20A may be a terminal mounted in the vehicle 10. Each user terminal 20 includes a processor 21, a main memory unit 22, an auxiliary memory unit 23, an input unit 24, an output unit 25, a communication unit 26, and a positional information sensor 27. They are connected to each other via a bus. Description of the processor 21, the main memory unit 22, and the auxiliary memory unit 23, which are similar to the processor 31, the main memory unit 32, and the auxiliary memory unit 33 in the server 30, will be omitted. Note that each user terminal 20 may be a single computer or multiple computers in cooperation. For example, the driver user terminal 20A may be composed of a computer mounted to the vehicle 10 and a computer carried by the driver user which operate in cooperation.

The input unit 24 is a means for receiving an input operation from a user, for example, a touch screen, a push-button, or the like. The output unit 25 is a means for presenting information to the user, for example, a liquid crystal display (LCD), an electroluminescence (EL) panel, a speaker, a lamp, or the like. The input unit 24 and the output unit 25 may constitute one touch screen display. The communication unit 26 is a communication means for connecting the user terminals 20 to the network N1. The communication unit 26 is, for example, a circuit for communication with other apparatuses (for example, the server 30) via the network N1 by utilizing a mobile communication service (a telecommunication network, such as 3rd Generation (3G) or long term evolution (LTE), or wireless communication, such as Wi-Fi).

The positional information sensor 27 acquires information on user terminals 20 in a predetermined cycle. The positional information sensor 27 is, for example, a global positioning system (GPS) receiving unit or a Wi-Fi communication unit. Note that the hardware configuration of the user terminals 20 is not limited to that illustrated in FIG. 2.

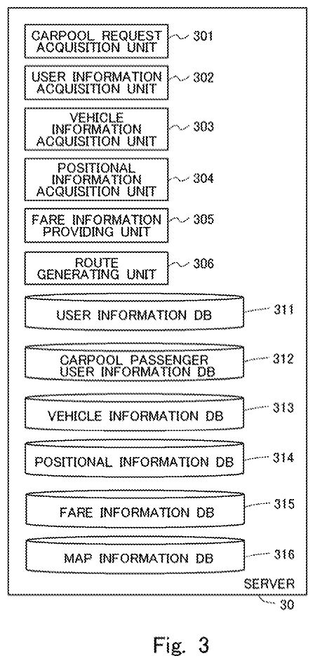

The function of the server 30 will now be explained. FIG. 3 is a diagram illustrating an example of the functional configuration of the server 30. The server 30 includes, as functional elements, a carpool request acquisition unit 301, a user information acquisition unit 302, a vehicle information acquisition unit 303, a positional information acquisition unit 304, a fare information providing unit 305, a route generating unit 306, a user information DB 311, a carpool passenger user information DB 312, a vehicle information DB 313, a positional information DB 314, a fare information DB 315, and a map information DB 316. The processor 31 in the server 30 executes processing in the carpool request acquisition unit 301, the user information acquisition unit 302, the vehicle information acquisition unit 303, the positional information acquisition unit 304, the fare information providing unit 305, and the route generating unit 306, using computer programs in the main memory unit 32. Note that any one of the functional components or part of their processing may be executed with a hardware circuit.

The user information DB 311, the carpool passenger user information DB 312, the vehicle information DB 313, the positional information DB 314, the fare information DB 315, and the map information DB 316 are constructed when programs in a database management system (DBMS) executed by the processor 31 manage data stored in the auxiliary memory unit 33. The user information DB 311, the carpool passenger user information DB 312, the vehicle information DB 313, the positional information DB 314, the fare information DB 315, and the map information DB 316 are, for example, relational databases.

Note that any one of the functional components of the server 30 or part of their processing may be executed with a different computer connected to the network N1.

The carpool request acquisition unit 301 acquires, for example, a carpool request from the potential user terminal 20C of a potential user who demands carpooling in the vehicle 10. A carpool request is information that includes a potential user's identifier and is information that the potential user uses to request for the ride of the vehicle 10. In the description below, the user terminal 20 that transmits a carpool request is treated as the potential user terminal 20C until the server 30 receives the carpool request, and the user terminal 20 that has transmitted a carpool request is treated as the carpool passenger user terminal 20B after the server 30 receives the carpool request. For this reason, carpool requests are generated in the potential user terminal 20C. A carpool request includes information on the ID of the vehicle 10 that has been selected by the potential user and is the vehicle 10 that the potential user demands to ride (hereinafter also referred to as “vehicle ID”). The vehicle ID is an identifier unique to the vehicle 10 and is associated with the driver user. Upon acquisition of a carpool request, the carpool request acquisition unit 301 associates the vehicle ID with the user ID of the carpool passenger user and stores it in the carpool passenger user information DB 312 which will be described later.

In addition, the user information acquisition unit 302 acquires, for example, information (user information) on the user corresponding to each user terminal 20. The user information includes, for example, the user ID associated with the user, a name, and an address, and in the case of the driver of the vehicle 10, includes a vehicle ID described later, a car model, a vehicle's color, a vehicle's number, and a vehicle's capacity. A user ID is an identifier unique to each user. User information is transmitted from the user terminal 20 to the server 30 and is registered to the server 30. Upon acquisition of user information, the user information acquisition unit 302 stores the user information in the user information DB 311 which will be described later.

The vehicle information acquisition unit 303 acquires information on the travel of the vehicle 10 (or the driver user). Note that information on the travel of the vehicle 10 will hereinafter be also referred to as vehicle information. The vehicle information includes information that is transmitted from the driver user terminal 20A to the server 30, and is related to the current location, destination, and travel period of the vehicle 10 (or the driver user). Upon acquisition of vehicle information, the vehicle information acquisition unit 303 stores the vehicle information in the vehicle information DB 313 which will be described later.

The positional information acquisition unit 304 acquires information on the current locations of potential users (positional information). Positional information on a potential user is transmitted from the potential user terminal 20C to the server 30 at regular intervals. Upon acquisition of positional information from the potential user terminal 20C, the positional information acquisition unit 304 stores the positional information in the positional information DB 314 which will be described later.

The fare information providing unit 305 calculates the fare of the vehicle 10 that occurs when a potential user currently demands to ride the vehicle 10, according to the number of current carpool passenger users. A relationship between the number of carpool passenger users and the fare of the vehicle 10 is stored in the fare information DB 315. The fare information providing unit 305 searches for potential users whose current location is within a predetermined range from the scheduled travel path of the vehicle 10. The scheduled travel path is generated in the route generating unit 306 which will be described below. Subsequently, the potential user terminal 20C of a potential user found by the searching is provided with information on the fare (fare information). The fare information provided to the potential user includes information on the destination of the vehicle 10. Note that the processing in the fare information providing unit 305 will hereinafter be also referred to as “fare information providing processing”.

The route generating unit 306 generates the travel path of the vehicle 10 so that it departs from the current location of the vehicle 10, goes through the current location of a carpool passenger user, and reaches the destination of the vehicle 10 (the predetermined place). The travel path is generated based on map information stored in the map information DB 316. The travel path is generated so that it follows a predetermined rule, for example, so that it provides the shortest travel distance of the vehicle 10 or the shortest travel time of the vehicle 10. The route generating unit 306 transmits the generated travel path to the driver user terminal 20A of the driver user. Similarly, the route generating unit 306 generates a scheduled travel path which is used in fare information providing processing. The scheduled travel path is a path extending from the current location of the vehicle 10 to the destination. The generated scheduled travel path of the vehicle 10 is transmitted to the fare information providing unit 305. The travel path and scheduled travel path can be generated using well-known techniques.

The user information DB 311 is made up with user information stored in the auxiliary memory unit 33 and is where association between each user and user information is performed.

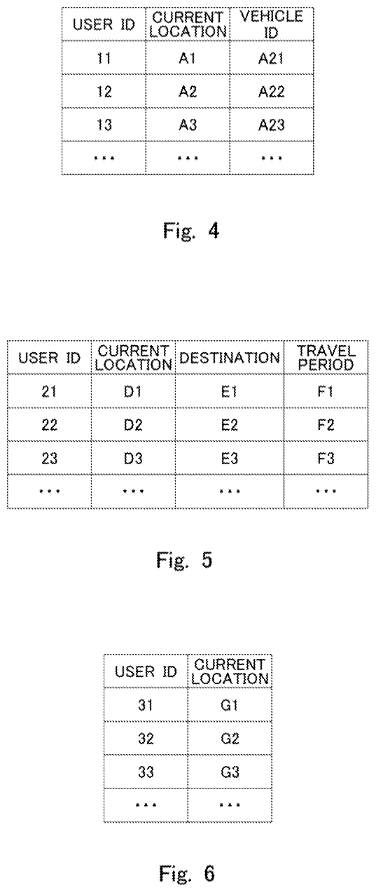

The carpool passenger user information DB 312 is made up with positional information on carpool passenger users and information on the vehicle ID of the vehicle 10 that the carpool passenger users are going to ride which are stored in the aforementioned auxiliary memory unit 33, and is where association of each carpool passenger user with positional information on the carpool passenger user and information on the vehicle ID is performed. The structure of information stored in the carpool passenger user information DB 312 will now be described with reference to FIG. 4. FIG. 4 is a diagram illustrating an example of the table configuration of information stored in the carpool passenger user information DB 312. A table of information stored in the carpool passenger user information DB 312 includes the fields of user ID, current location, and vehicle ID. In the user ID field, identification information for identifying carpool passenger users is input. In the current location field, information that indicates the current location of carpool passenger users and indicates the current locations of the corresponding carpool passenger user terminals 20B found when the server 30 receives carpool requests from these carpool passenger user terminals 20B is input. Note that the current location of each carpool passenger user may be the location where he/she demands to ride the vehicle 10, or a location related to positional information stored in the positional information DB 314 which will be described later. For example, positional information on each carpool passenger user may be transmitted from the carpool passenger user terminal 20B to the server 30 at regular intervals, and the server 30 receiving this positional information may update the current location field in the carpool passenger user information DB 312 in accordance with this positional information. In the vehicle ID field, information on the vehicle ID included in each carpool request is input. A current location is, for example, represented by a latitude and a longitude.

The vehicle information DB 313 is made up with information on the travel of the vehicle 10 (vehicle information) stored in the auxiliary memory unit 33 and is where association between each driver user and vehicle information is performed. Here, the structure of vehicle information stored in the vehicle information DB 313 will now be described with reference to FIG. 5. FIG. 5 is a diagram illustrating an example of the table configuration of vehicle information stored in the vehicle information DB 313. A vehicle information table includes the fields of user ID, current location, destination, and travel period. In the user ID field, identification information for identifying driver users is input. In the current location field, information indicating the current location of each vehicle 10 (or the current location of each driver user) is input. In the destination field, information indicating the final destination of the travel of each vehicle 10 is input. The current location and destination of each vehicle 10 are represented, for example, by a latitude and a longitude. In the travel period field, information indicating the period of the travel of each vehicle 10 is input. For example, information indicating the current location of the vehicle 10 may be transmitted from the driver user terminal 20A to the vehicle information acquisition unit 303 at regular intervals, and the vehicle information acquisition unit 303 receiving this information indicating the current location may update the current location field in the vehicle information DB 313 in accordance with this information indicating the current location.

The positional information DB 314 is made up with information indicating the current location of each potential user stored in the aforementioned auxiliary memory unit 33 and is where association between each potential user and positional information is performed. Here, the structure of positional information on each potential user stored in the positional information DB 314 will now be described with reference to FIG. 6. FIG. 6 is a diagram illustrating an example of the table configuration of positional information stored in the positional information DB 314. The potential user's positional information table includes the fields of user ID and current location. In the user ID field, identification information for identifying potential users is input. In the current location field, information indicating the current locations of potential users is input. Note that the current location of each potential user may be a pre-registered location where he/she demands to ride the vehicle 10. The current location of each potential user is represented, for example, by a latitude and a longitude. For example, positional information on each potential user may be transmitted from the potential user terminal 20C to the positional information acquisition unit 304 at regular intervals, and the positional information acquisition unit 304 receiving this positional information updates the current location field in the positional information DB 314 in accordance with this positional information.

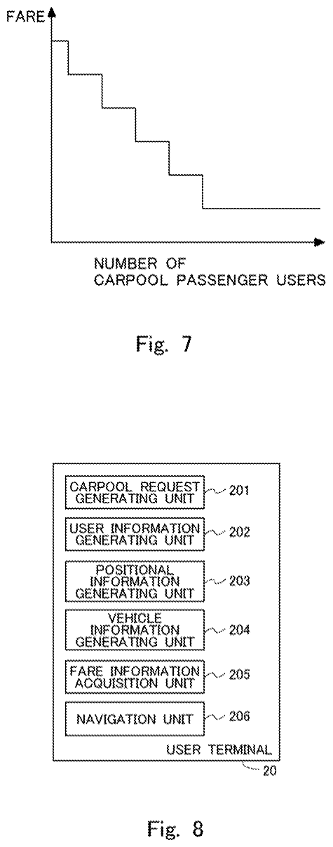

The fare information DB 315 is made up with fare information stored in the aforementioned auxiliary memory unit 33. FIG. 7 is a diagram illustrating a relationship between the number of carpool passenger users and fare. For example, the larger the number of current carpool passenger users, the lower the fare. The information illustrated in FIG. 7 is stored in the fare information DB 315 as fare information.

The map information DB 316 stores, as map information, for example, link data on roads (links), node data on node points, intersection data on intersections, search data for searching for routes, facility data on facilities, search data for searching for locations, and the like.

The function of each user terminal 20 will now be explained. FIG. 8 is a diagram illustrating an example of the functional configuration of the user terminal 20. The user terminal 20 includes, as functional components, a carpool request generating unit 201, a user information generating unit 202, a positional information generating unit 203, a vehicle information generating unit 204, a fare information acquisition unit 205, and a navigation unit 206. The processor 21 in the user terminal 20 executes processing in the carpool request generating unit 201, the user information generating unit 202, the positional information generating unit 203, the vehicle information generating unit 204, the fare information acquisition unit 205, and the navigation unit 206, using computer programs in the main memory unit 22. Note that any one of the functional components or part of their processing may be executed with a hardware circuit.

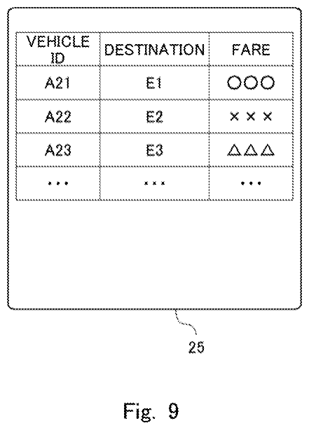

The carpool request generating unit 201 outputs an operating screen on the output unit 25 and generates a carpool request according to an input by a potential user to the input unit 24 of the potential user terminal 20C. The carpool request generating unit 201 is a functional element that operates in the potential user terminal 20C. For example, the carpool request generating unit 201 lists vehicles 10 available for carpooling on a touch screen display and, when a potential user selects one vehicle 10 from them through the input unit 24, generates a carpool request. FIG. 9 is a diagram illustrating an example of a screen for selecting a vehicle 10, displayed on the output unit 25 of the potential user terminal 20C. The output unit 25 presents vehicles ID, destinations, and fares corresponding to available vehicles 10. Each vehicle 10 is selectable when a potential user clicks the portion of the vehicle ID. When the potential user clicks the portion of the vehicle ID, a carpool request is generated. The carpool request generating unit 201 associates the generated carpool request with the user ID of the potential user and the vehicle ID of the vehicle 10 and transmits it to the server 30.

The user information generating unit 202 generates user information. The user information generating unit 202 is a functional element that operates in each of the driver user terminal 20A, the carpool passenger user terminal 20B, and the potential user terminal 20C. The user information generating unit 202 displays an operating screen for promoting the input of user information on the output unit 25 and generates user information according to a user's input to the input unit 24. The generated user information is transmitted by the user information generating unit 202 to the server 30. For example, when each user performs user registration, the user information generating unit 202 generates user information and transmits it to the server 30.

Moreover, the positional information generating unit 203 generates positional information on the potential user. The positional information generating unit 203 is a functional element that operates in the potential user terminal 20C. The positional information generating unit 203 generates positional information based on information acquired by the positional information sensor 27. The generated positional information is transmitted by the positional information generating unit 203 to the server 30. Note that positional information may be input by the potential user through the input unit 24 and stored in the auxiliary memory unit 23 in advance. The positional information generating unit 203 may generate positional information based on data stored in the auxiliary memory unit 23. Further, the positional information generating unit 203 may transmit positional information along with a user ID from the potential user terminal 20C to the server 30 at predetermined intervals (for example, 60 seconds). Upon reception of the positional information, the server 30 updates the current location field in the positional information DB 314 in accordance with this positional information.

The vehicle information generating unit 204 generates information on the travel of the vehicle 10 (vehicle information). In other words, information including information on the current location, destination, and travel period of the vehicle 10 is generated. The vehicle information generating unit 204 is a functional element that operates in the driver user terminal 20A. The vehicle information generating unit 204 displays an operating screen for promoting the input of vehicle information on the output unit 25 and generates vehicle information according to a driver user's input to the input unit 24. Note that the vehicle information generating unit 204 may detect the current location of the driver user terminal 20A on the basis of the positional information acquired by the positional information sensor 27 and this current location may be regarded as the current location of the vehicle 10. The generated vehicle information is transmitted by the vehicle information generating unit 204 to the server 30. Note that vehicle information may be input by the driver user through the input unit 24 in advance and stored in the auxiliary memory unit 23 of the driver user terminal 20A. The vehicle information generating unit 204 may generate vehicle information based on data stored in the auxiliary memory unit 23. Further, the vehicle information generating unit 204 may transmit information on the current location along with a user ID from the driver user terminal 20A to the server 30 at predetermined intervals (for example, 60 seconds). Upon reception of the information on the current location, the server 30 updates the current location field in the vehicle information DB 313 in accordance with this information on the current location.

The fare information acquisition unit 205 acquires fare information transmitted from the server 30. The fare information acquisition unit 205 is a functional element that operates in the potential user terminal 20C. The fare information acquired by the fare information acquisition unit 205 is stored in the auxiliary memory unit 23 and also transmitted to the carpool request generating unit 201. Note that, even after acquisition of the fare information, the potential user terminal 20C can force the output unit 25 to output an image according to the fare information stored in the auxiliary memory unit 23 in response to potential user's operation on the input unit 24. The fare information acquisition unit 205 may have a function of requesting the server 30 to transmit fare information.

The navigation unit 206 displays, on the output unit 25, the map of an area at or around the current location of the user terminal 20 (or the current location of the vehicle 10) according to map information and the like stored in the auxiliary memory unit 23. In addition, upon reception of a travel path from the server 30, the navigation unit 206 provides route guidance along the received travel path. At the time, the navigation unit 206 outputs the travel path to the output unit 25. The navigation unit 206 displays, for example, the map and the travel path on the display or guides to travel directions along the travel path with sounds. The function of the navigation unit 206 can be implemented by using a well-known technique. Although travel paths of vehicles 10 are generated in the route generating unit 306 of the server 30 in the carpool support system 1, this generation of travel paths may be performed in the navigation unit 206 of a user terminal 20.

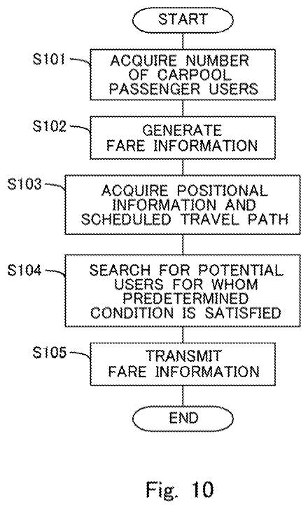

Fare information providing processing will now be explained. FIG. 10 is an example flow chart of fare information providing processing according to this embodiment. The fare information providing processing illustrated in FIG. 10 is executed by the fare information providing unit 305 for one vehicle 10 at predetermined intervals. Hence, in the case where multiple vehicles 10 exist, fare information providing processing is executed for each vehicle 10. Each time the number of carpool passenger users increases, fare information providing processing may be executed for the vehicle 10 for which the number of carpool passenger users has been increased. Here, it is assumed that the server 30 receives the driver user's user information and the vehicle 10's vehicle information from the driver user terminal 20A, and the potential user's user information and positional information from the potential user terminal 20C, and generation of a scheduled travel path has been completed.

In Step S101, the number of carpool passenger users for a vehicle 10 is acquired. The number of carpool passenger users is acquired from the carpool passenger user information DB 312. Here, the number of users for whom the vehicle ID corresponding to the vehicle 10 is input is calculated into the vehicle ID field in the carpool passenger user information DB 312.

Next, in Step S102, fare information is generated. The fare information providing unit 305 calculates the current fare of the vehicle 10 according to the number of carpool passenger users, and generates fare information according to the calculated fare. Fare information is generated as information including the current fare of the vehicle 10 and destination of the vehicle 10.

In Step S103, the positional information stored in the positional information DB 314 and the scheduled travel path of the vehicle 10 stored in the auxiliary memory unit 33 are acquired. The scheduled travel path of the vehicle 10, which may change with an increase in the number of carpool passenger users, is currently a path along which the vehicle 10 is scheduled to travel.

Subsequently, Step S104 searches for potential users for whom a predetermined condition for carrying the potential user to the destination of the vehicle 10 with the vehicle 10 is satisfied, on the basis of the positional information and scheduled travel path acquired in Step S103. The “predetermined condition” here is a condition for determining whether a potential user can be allowed to ride the vehicle 10 comparatively easily. To be specific, when the current location of the potential user is within a predetermined range from the scheduled travel path of the vehicle 10, it is determined that the predetermined condition is satisfied. A predetermined range here is a range in which the load on the vehicle 10 or the driver user falls within an allowable range even if the vehicle 10 changes the actual travel path from the scheduled travel path. In other words, if the current location of the potential user is within a predetermined range from the scheduled travel path of the vehicle 10, a change in the travel path of the vehicle 10 can be made relatively small, resulting in less load on the vehicle 10 or the driver user. The fare information providing unit 305 picks up all potential users for whom the predetermined condition is satisfied, according to the positional information on each potential user.

Subsequently, in Step S105, the fare information generated in Step S102 is transmitted to the potential user terminals 20C corresponding to the potential users picked up in Step S104. Afterwards, the processing illustrated in FIG. 10 ends.

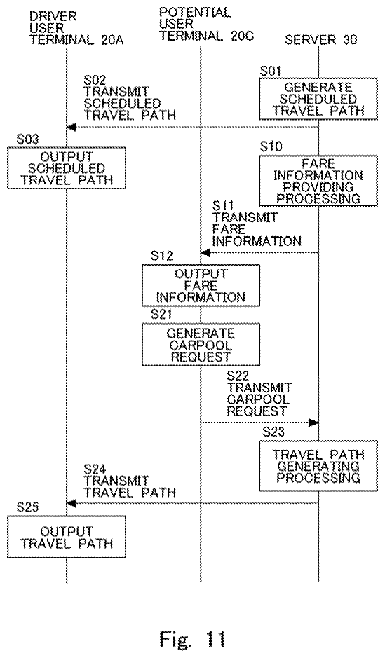

The operation of the carpool support system 1 will now be explained. FIG. 11 is a diagram illustrating a sequence of processing in the carpool support system 1. In the sequence diagram illustrated in FIG. 11, it is assumed that there are one driver user and one potential user, and the potential user demands to ride a vehicle 10. In addition, the current location of the driver user (or the current location of the vehicle 10) and the current location of the potential user are assumed to be transmitted from each user terminal 20 to the server 30 at predetermined intervals.

The server 30 generates a scheduled travel path of the vehicle 10 on the basis of the vehicle information stored in the vehicle information DB 313 (processing in S01). In S01, the server 30 generates the scheduled travel path of the vehicle 10 according to the current location and destination of the vehicle 10. Information on the generated scheduled travel path is transmitted from the server 30 to the driver user terminal 20A (processing in S02). Upon reception of the information on the scheduled travel path, the driver user terminal 20A outputs the scheduled travel path to the output unit 25 (processing in S03).

After transmitting the information on the scheduled travel path to the driver user terminal 20A, the server 30 executes fare information providing processing (processing in SI0). In S10, the server 30 executes the fare information providing processing illustrated in FIG. 10. In the fare information providing processing, the fare information is transmitted to the potential user terminal 20C (processing in Si). Upon reception of the fare information, the potential user terminal 20C forces the output unit 25 to output information (a vehicle ID, destination, and fare) corresponding to the fare information as illustrated in FIG. 9 (processing in S12).

Since the fare of the vehicle 10 is output to the potential user terminal 20C, the potential user can know the current fare of the vehicle 10. When the potential user demands to travel to the destination of the vehicle 10 (a predetermined place), he/she clicks the vehicle ID displayed on the screen of the potential user terminal 20C. In response to this, the potential user terminal 20C generates a carpool request (processing in S21). Further, a carpool request is transmitted from the potential user terminal 20C to the server 30 (processing in S22). Upon reception of the carpool request, the server 30 generates a travel path of the vehicle 10 on the basis of the positional information on the potential user and the vehicle information on the vehicle 10 (processing in S23). The travel path is generated so that the vehicle 10 goes through the current location of the vehicle 10, the current location of the carpool passenger user, and the destination of the vehicle 10, for example, in the shortest distance. Information on the generated travel path is transmitted from the server 30 to the driver user terminal 20A (processing in S24). Upon reception of the information on the travel path, the driver user terminal 20A outputs the travel path to the output unit 25 and guides the driver user along the travel path (processing in S25). After the travel path is generated in S23, fare information providing processing may be executed to provide fare information to other potential users. In particular, the processing from S10 to S25 may be repeated.

As described above, the carpool support system 1 according to this embodiment reduces the fare of a vehicle 10 according to the number of users who ride the vehicle 10, allowing users to ride the vehicle 10 more easily. Thus, the users can be led to the predetermined place. This can promote carpooling in the vehicle 10 traveling to the predetermined place. Moreover, more users can be carried to the destination; hence, when the destination is a commercial facility, for example, the sales of the commercial facility can be increased.

### Second Embodiment

In this embodiment, a future fare is estimated according to the number of carpool passenger users in the past (the number of users who actually carpooled in a vehicle 10), and the estimated fare is provided to potential users. For example, the number of carpool passenger users heading to a predetermined place may change according to the date, day, time, weather, or the like. Aside from that, for example, in the event of sale, event, or the like at a commercial facility, the number of carpool passenger users is estimated to increase from a usual number. If the number of carpool passenger users in the past corresponding to each condition is stored in the server 30, the number of carpool passenger users corresponding to each condition can be estimated. In addition, the fare dependent on the estimated number of carpool passenger users is calculated so that a future fare can be estimated. Note that the fare acct each time range is estimated in the case described below.

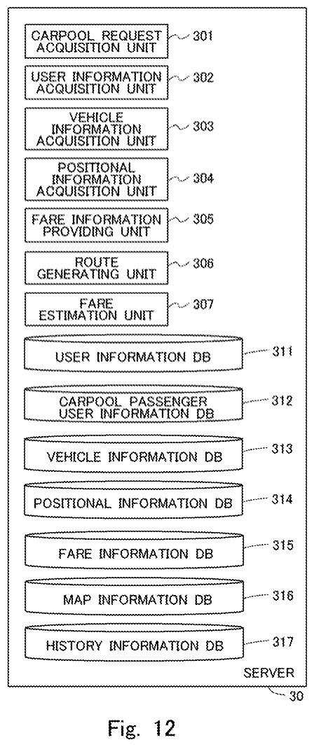

FIG. 12 is a diagram illustrating an example of the functional configuration of the server 30. Features different from in the functional configuration of the server 30 illustrated in FIG. 3 will be mainly described. The server 30 further includes a fare estimation unit 307 and a history information DB 317 as functional elements. The processor 31 of the server 30 executes the processing in the fare estimation unit 307 through computer programs in the main memory unit 32. Note that any one of the functional components or part of their processing may be executed with a hardware circuit. The history information DB 317 is constructed when programs in a database management system (DBMS) executed by the processor 31 manage data stored in the auxiliary memory unit 33. The history information DB 317 is a relational database, for example.

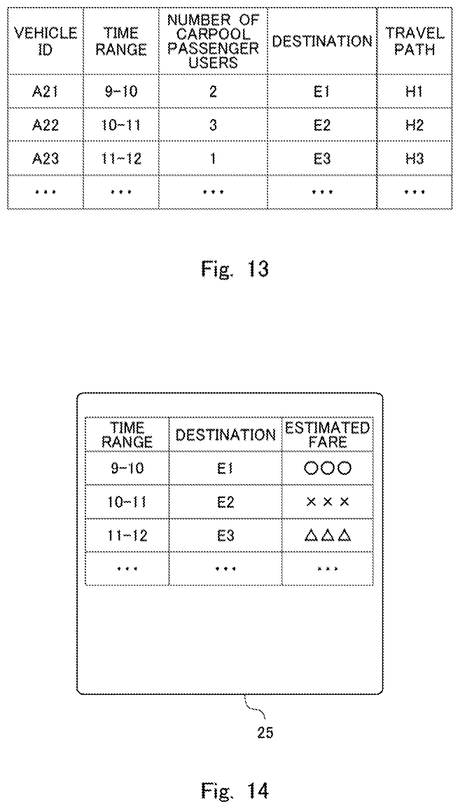

The history information DB 317 is made up with information on the number of carpool passenger users in the past (hereinafter also referred to as history information) stored in the auxiliary memory unit 33 and is where association between each driver user and history information is performed. The structure of history information stored in the history information DB 317 will now be described with reference to FIG. 13. FIG. 13 is a diagram illustrating an example of the table configuration of history information stored in a history information DB. A history information table includes the fields of vehicle ID, time range, number of carpool passenger users, destination, and travel path. In the vehicle ID field, identification information for identifying vehicles 10 is input. In the time range field, information for identifying time ranges in which each vehicle 10 traveled in the past is input. The time ranges are hourly divided. In the number of carpool passenger users field, for example, information indicating the number of carpool passenger users found at the time when the vehicle 10 arrives at the destination is input. In the destination field, information indicating the destination of the travel of each vehicle 10 is input. In the travel path field, information indicating the travel path of the travel of each vehicle 10 is input. As described above, in the history information DB 317, information on the time range, the number of carpool passenger users, destination, and travel path related to each carpooling and associated with the vehicle 10 that was used for the carpooling is input.

The fare estimation unit 307 calculates the fare of a vehicle 10 assumed to occur when a potential user demands to ride the vehicle 10 in the future, according to the number of current carpool passenger users found in the past. Fare calculation is performed, for example, for each destination and in each time range. The fare estimation unit 307 refers to the history information DB 317 to extract the number of carpool passenger users for each destination in each time range. In the case where there are multiple vehicles 10 heading to the same destination in the same time range, the average of the numbers of carpool passenger users in them may be employed. The fare estimation unit 307 then calculates the fare for the number of carpool passenger users found in the past. Note that, regarding a relationship between the number of carpool passenger users and the fare of the vehicle 10, information stored in the fare information DB 315 is used. The fare estimation unit 307 searches for potential users whose current position is within a predetermined range from the past travel path of the vehicle 10. Subsequently, the potential user terminal 20C of a potential user found by the searching is provided with information on the estimated fare (estimated fare information). The estimated fare information provided to the potential user includes information on the destination and time range of the vehicle 10. The estimated fare information is received by the fare information acquisition unit 205 of the potential user terminal 20C.

Upon reception of the estimated fare information, the fare information acquisition unit 205 of the potential user terminal 20C outputs the time range, destination, and estimated fare based on the estimated fare information to the output unit 25. FIG. 14 is a diagram illustrating an example of a screen displayed on the output unit 25 of the potential user terminal 20C that has received estimated fare information. The output unit 25 displays a time range, destination, and estimated fare for each vehicle 10.

Estimated fare information is transmitted, for example, to the potential user terminal 20C during a period before the corresponding time range (for example, the day before the corresponding time range). In addition, for example, estimated fare information corresponding to each time range during a week may be transmitted to the potential user terminal 20C during the week before that week. Since estimated fare information is transmitted to the potential user terminal 20C as described above, potential users can receive information for deciding a time range for travel, enhancing the convenience of potential users. Moreover, potential users can know in advance how much the fare will decrease in the future, so that the potential users can be led to a predetermined place in the future. This can promote carpooling in vehicles 10 traveling to predetermined places.

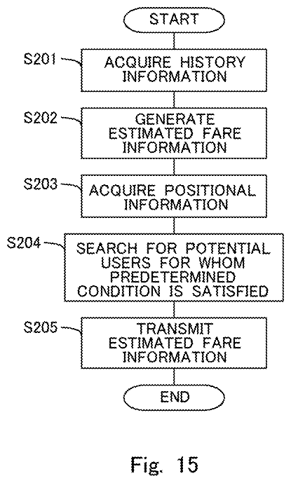

FIG. 15 is an example flow chart of processing for providing estimated fare information to a potential user, according to this embodiment. The processing illustrated in FIG. 15 is executed by the fare estimation unit 307 at predetermined intervals. Here, it is assumed that the server 30 receives the potential user's user information and positional information from the potential user terminal 20C, and the history information DB 317 stores history information.

In Step S201, history information stored in the history information DB 317 is acquired. Next, in Step S202, estimated fare information is generated. The fare estimation unit 307 refers to the history information DB 317 to acquire the number of carpool passenger users for each destination in each time range. The fare is calculated for each time range and each destination on the basis of the number of carpool passenger users acquired in the manner described above. Subsequently, estimated fare information is generated on the basis of the calculated fare. Estimated fare information is generated as information including the fare of the vehicle 10 and destination of the vehicle 10 in each past time range.

In Step S203, positional information stored in the positional information DB 314 is acquired. Subsequently, Step S204 searches for potential users for whom a predetermined condition on the basis of the positional information acquired in Step S203 and the travel path acquired in Step S201. The “predetermined condition” here is, when it is assumed that the vehicle 10 related to the history information currently travels, a condition for determining whether a potential user can be allowed to ride the vehicle 10 comparatively easily. To be specific, when the current location of the potential user is within a predetermined range from the past travel path of the vehicle 10, it is determined that the predetermined condition is satisfied. The predetermined range here is the same as the predetermined range according to the first embodiment. The fare information providing unit 305 picks up all potential users for whom the predetermined condition is satisfied, according to the positional information on each potential user.

Subsequently, in Step S205, the estimated fare information generated in Step S202 is transmitted to the potential user terminals 20C corresponding to the potential users picked up in Step S204. Afterwards, the processing illustrated in FIG. 15 ends.

As explained above, with the carpool support system 1 according to this embodiment, potential users can know a fare estimated assuming that they traveled to a destination in the future. Hence, potential users who knew periods during which the fare decreases can be easily led to a predetermined place. This can promote carpooling in vehicles 10 traveling to predetermined places.

### Other Embodiments

The above-described embodiment is merely illustrative and appropriate modification can be made without departing from the scope of the present disclosure.

The processing and means described in this disclosure can be freely combined unless inconsistencies arise.

In addition, processing supposed to be done with one apparatus according to the above description may be executed with multiple apparatuses. Alternatively, processing supposed to be done with different apparatuses according to the above description may be executed with one apparatus. In the computer system, the type of hardware configuration (server configuration) used to implement each function can be flexibly changed.

The present disclosure can be implemented when a computer program having the functions that have been described in the above embodiment is supplied to a computer, and one or more processors in the computer read and execute the program. Such a computer program may be provided to the computer via a non-transitory computer-readable memory medium that can be connected to the computer's system bus or via a network. Examples of non-transitory computer-readable memory medium include any type of disks such as magnetic disks (such as floppy (registered trademark) disks and hard disk drives (HDDs)), and optical disks (such as CD-ROMs, DVD disks, and Blu-ray disks), read only memories (ROMs), random access memories (RAMs), EPROMs, EEPROMs, magnetic cards, flash memories, optical cards, and any type of media suitable for storing electronic instructions.

What is claimed is:

1. An information processing apparatus comprising a controller, wherein
the controller acquires a number of carpool passenger users who are users scheduled to carpool in a vehicle that travels to a predetermined place,
the controller sets a cost needed for potential users who are users different from the carpool passenger users to ride the vehicle, on the basis of the number of carpool passenger users, and
the controller provides information on the cost to the potential users present within a predetermined range from a scheduled path of the vehicle traveling to the predetermined place.

2. The information processing apparatus according to claim 1, wherein
when the potential user demands to carpool in the vehicle, the controller generates the path that passes through the location of the potential user, and
the controller provides the generated path to the driver of the vehicle or to the vehicle.

3. The information processing apparatus according to claim 1, wherein the controller sets the cost so that the larger the number of carpool passenger users, the lower the cost.

4. The information processing apparatus according to claim 1, wherein
the controller calculates an estimated cost on the basis of the number of carpool passenger users acquired in the past, the estimated cost being the cost needed for the potential users to ride the vehicle scheduled to travel to the predetermined place in the future, and
the controller provides information on the calculated estimated cost to the potential users.

5. An information processing method in a computer, comprising:
acquiring a number of carpool passenger users who are users scheduled to carpool in a vehicle that travels to a predetermined place;
setting a cost needed for potential users who are users different from the carpool passenger users to ride the vehicle, on the basis of the number of carpool passenger users; and
providing information on the cost to the potential users present within a predetermined range from a scheduled path of the vehicle traveling to the predetermined place.

6. A non-transitory storage medium stored with an information processing program,
the information processing program for causing a computer to:
acquire a number of carpool passenger users who are users scheduled to carpool in a vehicle that travels to a predetermined place;
set a cost needed for potential users who are users different from the carpool passenger users to ride the vehicle, on the basis of the number of carpool passenger users; and
provide information on the cost to the potential users present within a predetermined range from a scheduled path of the vehicle traveling to the predetermined place.
